(19) United States
(12) Patent Application Publication
(10) Pub. No.: US 2024/0077207 A1
(43) Pub. Date: Mar. 7, 2024

(54) HEATING COOKING APPARATUS

(71) Applicant: SHARP KABUSHIKI KAISHA, Sakai City, Osaka (JP)

(72) Inventors: MASAYUKI IWAMOTO, Sakai City, Osaka (JP); KAORU TOMISHIGE, Sakai City, Osaka (JP); YU SHINOHARA, Sakai City, Osaka (JP)

(21) Appl. No.: 18/273,567

(22) PCT Filed: Feb. 21, 2022
(86) PCT No.: PCT/JP2022/006925

§ 371 Date: Jul. 21, 2023

(30) Foreign Application Priority Data
Feb. 26, 2021 (JP) 2021-030097

(51) Int. Cl. F24C 15/02; F24C 7/02; F24C 7/08

(52) U.S. Cl. CPC F24C 15/02; F24C 7/02; F24C 7/081

(57) ABSTRACT

A heating cooking apparatus includes a heating cooking unit, a lid portion, a detection unit, light source units, and a control unit. The heating cooking unit includes a heating cooking chamber communicated with an opening. The lid portion moves between a closed position at which the lid portion covers the opening and an open position at which the lid portion opens the opening. The detection unit detects whether the lid portion is present at the closed position. The light source units, emit light into the heating cooking chamber. The control unit controls the light source units, when the detection unit detects that either a state of the lid portion being present at the closed position or a state of the lid portion not being present at the closed position is maintained for a predetermined period of time or longer.

### TECHNICAL FIELD

The present invention relates to a heating cooking apparatus.

### BACKGROUND ART

PTL 1 discloses a heating cooking device. The heating cooking device disclosed in PTL 1 includes a heating chamber and a light source. The heating chamber accommodates an object to be heated. The light source is disposed at a ceiling portion of the heating chamber. The light source emits light into the heating chamber.

### CITATION LIST

### Patent Literature

PTL 1: JP 2017-129295 A

### SUMMARY OF INVENTION

### Technical Problem

Incidentally, some heating cooking devices include a detection unit that detects whether a lid portion is present at a closed position. Then, when the heating chamber is opened, the light source emits light into the heating chamber, and when the heating chamber is closed, the light source stops emitting the light into the heating chamber. However, when the lid portion is closed, the lid portion may vibrate due to an impact or the like generated when the lid portion is closed. As a result, the light source sometimes emits the light or stops emitting the light. In other words, the light source sometimes flashes on and off when the lid portion is closed.

In light of the problem described above, an object of the present invention is to provide a heating cooking apparatus capable of inhibiting a light source from flashing on and off in an unintended manner.

### Solution to Problem

According to an aspect of the present invention, a heating cooking apparatus includes a heating cooking unit, a lid portion, a detection unit, a light source unit, and a control unit. The heating cooking unit includes an opening and a heating cooking chamber communicated with the opening. The lid portion moves between a closed position at which the lid portion covers the opening and an open position at which the lid portion opens the opening. The detection unit detects whether the lid portion is present at the closed position. The light source unit emits light into the heating cooking chamber. The control unit controls the light source unit. The control unit controls the light source unit when the detection unit detects that either a state of the lid portion being present at the closed position or a state of the lid portion not being present at the closed position is maintained for a predetermined period of time or longer.

### Advantageous Effects of Invention

A heating cooking apparatus according to the present invention can inhibit a light source from flashing on and off in an unintended manner.

### BRIEF DESCRIPTION OF DRAWINGS

FIG. 1 is a perspective view illustrating a pull-out type heating cooking apparatus according to a first embodiment of the present invention.

FIG. 2 is a right side view illustrating the pull-out type heating cooking apparatus according to the first embodiment.

FIG. 3 is a top view illustrating the pull-out type heating cooking apparatus according to the first embodiment.

FIG. 4 is a front view illustrating the pull-out type heating cooking apparatus according to the first embodiment.

FIG. 5 is an exploded perspective view illustrating a pull-out body according to the first embodiment.

FIG. 6 is a perspective view illustrating an appearance of a part of the pull-out body according to the first embodiment.

FIG. 7A is a cross-sectional view illustrating a connecting member and a member to be connected according to the first embodiment.

FIG. 7B is a cross-sectional view illustrating the connecting member and the member to be connected according to the first embodiment.

FIG. 7C is a cross-sectional view illustrating the connecting member and the member to be connected according to the first embodiment.

FIG. 7D is a cross-sectional view illustrating the connecting member and the member to be connected according to the first embodiment.

FIG. 7E is a cross-sectional view illustrating the connecting member and the member to be connected according to the first embodiment.

FIG. 8 is a cross-sectional view of the pull-out type heating cooking apparatus according to the first embodiment.

FIG. 9 is a block diagram illustrating a configuration of the pull-out type heating cooking apparatus according to the first embodiment.

FIG. 10 is a flowchart for explaining a control method by the pull-out type heating cooking apparatus according to the first embodiment.

FIG. 11 is a perspective view illustrating an appearance of a cabinet to which a pull-out type heating cooking apparatus according to the first embodiment is attached.

FIG. 12 is a flowchart for explaining a control method by the pull-out type heating cooking apparatus according to a second embodiment.

### DESCRIPTION OF EMBODIMENTS

Hereinafter, embodiments of a pull-out type heating cooking apparatus according to the present invention will be described with reference to the drawings. Note that, in the drawings, the same or equivalent components are denoted by the same reference numerals and signs, and description thereof will not be repeated.

### First Embodiment

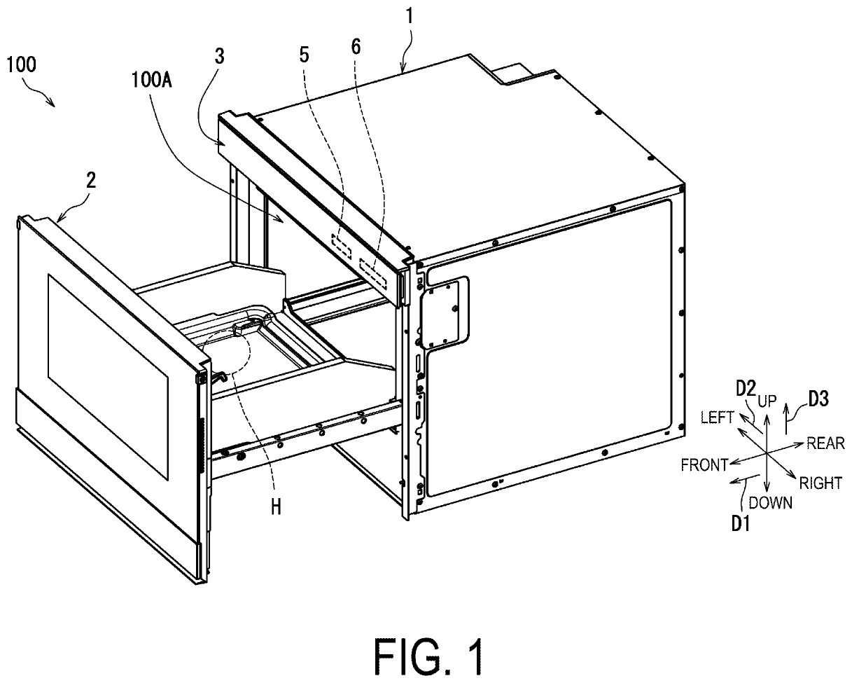

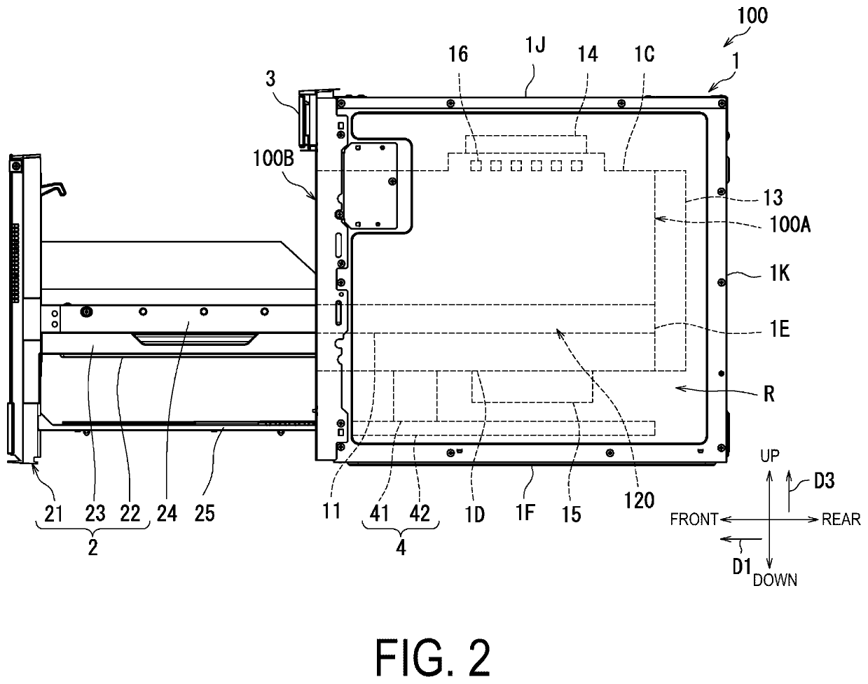

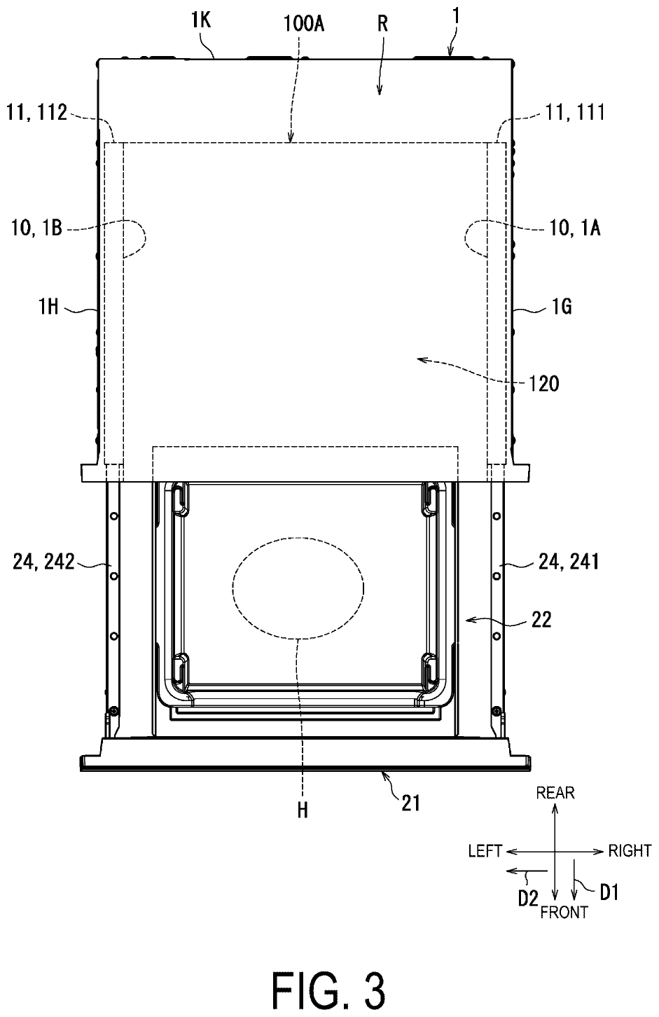

A pull-out type heating cooking apparatus 100 will be described with reference to FIG. 1 to FIG. 3. FIG. 1 is a perspective view illustrating the pull-out type heating cooking apparatus 100. FIG. 2 is a right side view illustrating the pull-out type heating cooking apparatus 100. FIG. 3 is a top view illustrating the pull-out type heating cooking apparatus 100. In more detail, FIG. 1 to FIG. 3 illustrate the pull-out type heating cooking apparatus 100 in a state in which a pull-out body 2 is pulled out. Further, FIG. 1 illustrates an external appearance of the pull-out type heating cooking apparatus 100 as viewed diagonally from the upper front right. The pull-out type heating cooking apparatus 100 is an example of a “heating cooking apparatus”.

As illustrated in FIG. 1, the pull-out type heating cooking apparatus 100 heats and cooks an object H to be heated. The object H to be heated is, for example, foodstuff. The pull-out type heating cooking apparatus 100 includes a heating chamber 1, the pull-out body 2, an operation panel 3, a control unit 5, and a storage unit 6. The heating chamber 1 is an example of a “heating cooking unit”.

In the present embodiment, a side at which the operation panel 3 of the pull-out type heating cooking apparatus 100 is disposed is defined as a front side of the pull-out type heating cooking apparatus 100, and a side opposite to the front side (rear face side) is defined as a rear side of the pull-out type heating cooking apparatus 100. Further, a right side when the pull-out type heating cooking apparatus 100 is viewed from the front side is defined as a right side of the pull-out type heating cooking apparatus 100, and a side opposite to the right side is defined as a left side of the pull-out type heating cooking apparatus 100. Further, in a direction orthogonal to a front-rear direction and a left-right direction of the pull-out type heating cooking apparatus 100, a side at which the operation panel 3 is disposed is defined as an upper side of the pull-out type heating cooking apparatus 100, and a side opposite to the upper side (bottom side) is defined as a lower side of the pull-out type heating cooking apparatus 100. Note that these orientations do not limit the orientation of the pull-out type heating cooking apparatus 100 when in use.

As illustrated in FIG. 1 to FIG. 3, the heating chamber 1 is a box-like member. Specifically, the heating chamber 1 includes a right outer wall 1G, a left outer wall 1H, a top outer wall 1J, a bottom outer wall 1F, and a back outer wall 1K. Then, the heating chamber 1 further includes a heating cooking chamber 100A.

The pull-out body 2, on which the object H to be heated is placed, can be pulled out in a first direction D1 from the heating cooking chamber 100A. The first direction D1 is an example of a “predetermined direction”. The first direction D1 is the forward direction. A third direction D3 intersects the first direction D1. In a first embodiment, the third direction D3 is orthogonal to the first direction D1. In the first embodiment, the third direction D3 is the upward direction (the direction opposite to the vertical direction). Specifically, the pull-out body 2 includes a lid portion 21, a placing portion 22, and a support portion 23.

The heating cooking chamber 100A includes an accommodation space 120 that accommodates the object H to be heated. The shape of the heating cooking chamber 100A is, for example, a substantially rectangular parallelepiped shape. Specifically, the heating cooking chamber 100A includes a pair of side wall portions 10, a back wall 1E, and an opening 100B. The opening 100B opens toward the first direction D1. The opening 100B communicates with the outside of the heating cooking chamber 100A. The back wall 1E is disposed in the direction opposite to the first direction D1 with respect to the opening 100B. In other words, the opening 100B faces the back wall 1E.

The pair of side wall portions 10 extend along the first direction D1 from the back wall 1E. In addition, the pair of side wall portions 10 face each other in a second direction D2. The second direction D2 is the left direction. Specifically, the pair of side wall portions 10 includes a right wall 1A and a left wall 1B. The heating cooking chamber 100A further includes a top wall 1C and a bottom wall 1D. Materials of the right wall 1A, the left wall 1B, the top wall 1C, the bottom wall 1D, and the back wall 1E are, for example, a metal.

The heating chamber 1 further includes a space R between the heating chamber 1 and the heating cooking chamber 100A. Specifically, the heating chamber 1 further includes the space R between the bottom wall 1D and the bottom outer wall 1F. The heating chamber 1 further includes the space R between the right wall 1A and the right outer wall 1G. The heating chamber 1 further includes the space R between the left wall 1B and the left outer wall 1H. The heating chamber 1 further includes the space R between the top wall 1C and the top outer wall 1J. The heating chamber 1 further includes the space R between the back wall 1E and the back outer wall 1K.

As illustrated in FIG. 3, the pull-out type heating cooking apparatus 100 further includes a pair of rail members 11. Specifically, one rail member of the pair of rail members 11 includes a right side rail member 111, and the other rail member of the pair of rail members 11 includes a left side rail member 112. The right side rail member 111 and the left side rail member 112 face each other in the second direction D2.

Each of the right side rail member 111 and the left side rail member 112 is disposed in the heating chamber 1. Specifically, each of the right side rail member 111 and the left side rail member 112 is disposed between the heating chamber 1 and the heating cooking chamber 100A. More specifically, the right side rail member 111 is fixed at the right wall 1A in the space R between the right wall 1A and the right outer wall 1G. The left side rail member 112 is fixed at the left wall 1B in the space R between the left wall 1B and the left outer wall 1H. Particularly, each of the right side rail member 111 and the left side rail member 112 extends in the first direction D1.

Meanwhile, the pull-out type heating cooking apparatus 100 further includes a pair of slide members 24. Specifically, one slide member of the pair of slide members 24 includes a right side slide member 241, and the other slide member of the pair of slide members 24 includes a left side slide member 242. The right side slide member 241 and the left side slide member 242 face each other in the second direction D2.

Each of the right side slide member 241 and the left side slide member 242 is disposed at the lid portion 21. Specifically, one end portion of the right side slide member 241 is attached to a right edge portion of the lid portion 21. One end portion of the left side slide member 242 is attached to a left edge portion of the lid portion 21. Particularly, each of the right side slide member 241 and the left side slide member 242 extends in a direction opposite to the first direction D1 from the lid portion 21.

The right side slide member 241 is slidably supported by the right side rail member 111. The left side slide member 242 is slidably supported by the left side rail member 112.

As illustrated in FIG. 2, the pull-out type heating cooking apparatus 100 further includes a support member 25. The support member 25 supports the lid portion 21. One end portion of the support member 25 is attached to a center portion in the left-right direction of the lid portion 21 and below the placing portion 22. The support member 25 is a plate-like member extending in the direction opposite to the first direction D1 from the lid portion 21. The support member 25 includes a rack portion. The rack portion includes teeth. The support member 25 may be a single plate-like member or a plurality of plate-like members.

Meanwhile, the pull-out type heating cooking apparatus 100 further includes a drive mechanism 4. The drive mechanism 4 causes the lid portion 21 to move along the first direction D1 with respect to the heating cooking chamber 100A. Specifically, the drive mechanism 4 drives the support member 25. The drive mechanism 4 is positioned below the heating cooking chamber 100A. Specifically, the drive mechanism 4 is accommodated in the space R between the bottom wall 1D and the bottom outer wall 1F. For example, the drive mechanism 4 includes a drive motor 41, a pinion, and a drive rail 42. The drive rail 42 is fixed in the space R between the bottom wall 1D and the bottom outer wall 1F. The drive rail 42 is a member having the first direction D1 as the longitudinal direction. The support member 25 is slidably supported by the drive rail 42. The drive motor 41 rotates the pinion.

The pinion engages with the rack portion of the support member 25. The support member 25 moves in the first direction D1 as a result of the rotation of the pinion. Note that the drive mechanism 4 may drive at least one among the support member 25, the right side slide member 241, and the left side slide member 242. Furthermore, when the right side slide member 241 and the left side slide member 242 are driven, the drive mechanism 4 may be positioned more to the side than the heating cooking chamber 100A.

As illustrated in FIG. 1, the operation panel 3 receives an operation from a user. The operation includes, for example, a cooking method for heating and cooking the object H to be heated, or information about movement of the lid portion 21 between the closed position and the open position thereof. Specifically, the operation panel 3 includes a display unit. The display unit displays various pieces of information. Specifically, the display unit includes a liquid crystal panel.

The storage unit 6 is constituted by a random access memory (RAM) and a read only memory (ROM). The storage unit 6 stores a control program for controlling an operation of each unit of the pull-out type heating cooking apparatus 100. The storage unit 6 stores setting information input when the operation panel 3 is operated.

The control unit 5 is a hardware circuit that includes a processor such as a central processing unit (CPU). The control unit 5 executes the control program stored in the storage unit 6.

As illustrated in FIG. 2, the pull-out type heating cooking apparatus 100 further includes a first air sending unit 14, a second air sending unit 13, a grill unit 16, and a microwave supply unit 15. The first air sending unit 14 circulates air between the first air sending unit 14 and the interior of the heating cooking chamber 100A. The second air sending unit 13 circulates air between the second air sending unit 13 and the interior of the heating cooking chamber 100A. The grill unit 16 heats and cooks the object H to be heated by conducting heat generated by a heater to the object H to be heated. The microwave supply unit 15 supplies microwaves into the heating cooking chamber 100A.

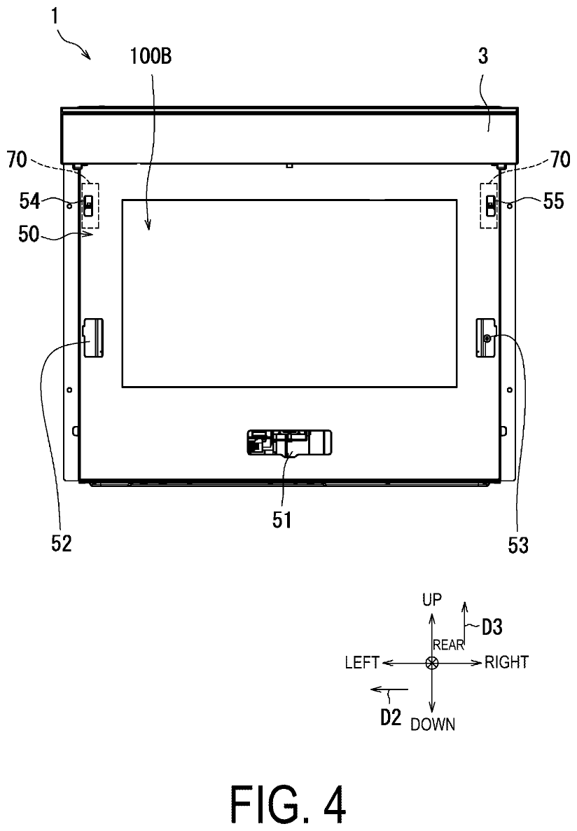

Next, the pull-out type heating cooking apparatus 100 will be described in detail with reference to FIG. 4. FIG. 4 is a front view illustrating the pull-out type heating cooking apparatus 100 according to the first embodiment. In more detail, FIG. 4 is a front view illustrating the pull-out type heating cooking apparatus 100 according to the first embodiment in a state in which the pull-out body 2 is removed.

As illustrated in FIG. 1 to FIG. 4, the heating chamber 1 further includes a panel 50 on the front face side. The panel 50 is an example of a “first face”. The opening 100B has a rectangular shape. The panel 50 is disposed around the outer periphery of the opening 100B. Specifically, the panel 50 is a plate-like member having a rectangular ring shape. The panel 50 includes a first through hole 51, a second through hole 52, a third through hole 53, a fourth through hole 54, and a fifth through hole 55.

The first through hole 51, the second through hole 52, the third through hole 53, the fourth through hole 54, and the fifth through hole 55 are formed around the opening 100B. In more detail, the first through hole 51 is formed at a position on the lower side of the opening 100B. The second through hole 52 is formed at a position on the left side of the opening 100B. The third through hole 53 is formed at a position on the right side of the opening 100B. The fourth through hole 54 is formed at a position on the left side of the opening 100B and on the upper side of the second through hole 52. The fifth through hole 55 is formed at a position on the right side of the opening 100B and on the upper side of the third through hole 53.

The support member 25 is inserted into the first through hole 51. The right side slide member 241 is inserted into the third through hole 53. The left side slide member 242 is inserted into the second through hole 52.

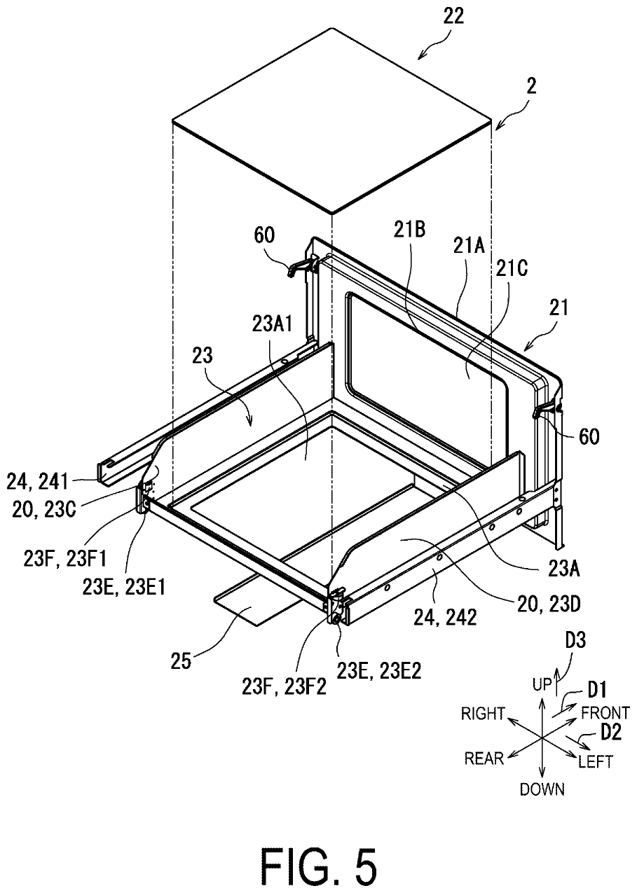

Next, the pull-out body 2 will be described in detail with reference to FIG. 5. FIG. 5 is an exploded perspective view illustrating the pull-out body 2 according to the first embodiment. As illustrated in FIG. 5, the lid portion 21 is a plate-like member having a substantially rectangular shape. Specifically, the lid portion 21 includes a glass plate portion 21C having a rectangular shape, a metal plate positioned at the outer periphery of the glass plate portion 21C, and a metal comb portion positioned at the outer periphery of the metal plate.

The glass plate portion 21C includes a first glass plate, a second glass plate, and a third glass plate. The second glass plate faces the first glass plate. The third glass plate faces the second glass plate. In other words, the glass plate portion 21C includes three layers of glass plates. The metal comb portion has, for example, a choke structure, and suppresses leakage of microwaves. The lid portion 21 includes a front face 21A and a rear face 21B. The rear face 21B is an example of a “second face”.

The lid portion 21 can open and close the opening 100B on the front side of the heating cooking chamber 100A. Specifically, the lid portion 21 moves between a closed position and an open position. The open position indicates a position at which the lid portion 21 opens the opening 100B. On the other hand, the closed position indicates a position at which the lid portion 21 covers the opening 100B.

The lid portion 21 closes the opening 100B on the front side of the heating cooking chamber 100A, in a state in which the pull-out body 2 is retracted into the heating cooking chamber 100A. In detail, the closed position indicates a position at which the panel 50 and the rear face 21B face each other. In more detail, the closed position indicates a position at which a predetermined distance is provided between the panel 50 and the rear face 21B, or a position at which the panel 50 and the rear face 21B come into contact with each other. The predetermined distance is, for example, 0.5 mm. The position at which the panel 50 and the rear face 21B come into contact with each other is, for example, a position at which the panel 50 and the rear face 21B come into close contact with each other.

The object H to be heated can be placed on the placing portion 22. Specifically, the placing portion 22 has a placing surface on which the object H to be heated is placed. The material of the placing portion 22 is a non-metal, and is preferably ceramic or glass, for example.

The support portion 23 is attached to the lid portion 21 and supports a peripheral edge portion of the placing portion 22 such that the placing portion 22 is held in a horizontal state. Specifically, the support portion 23 includes a bottom plate portion 23A and a pair of wall portions 20. The material of the support portion 23 is, for example, a metal.

The bottom plate portion 23A includes a rectangular opening 23A1. The rectangular opening 23A1 is positioned at substantially a center portion of the bottom plate portion 23A.

One wall portion of the pair of wall portions 20 includes a right side plate portion 23C, and the other wall portion of the pair of wall portions 20 includes a left side plate portion 23D. Each of the right side plate portion 23C and the left side plate portion 23D extends substantially along the first direction D1. The right side plate portion 23C and the left side plate portion 23D face each other substantially in the second direction D2. More specifically, the right side plate portion 23C and the left side plate portion 23D extend upward from the peripheral edge portion of the bottom plate portion 23A. The placing portion 22 is fitted among the lid portion 21, the right side plate portion 23C, and the left side plate portion 23D. The peripheral edge portion of the placing portion 22 is fixed to an upper surface of the peripheral edge portion of the bottom plate portion 23A.

The support portion 23 further includes a pair of rollers 23E and a pair of rollers 23F. The pair of rollers 23E and the pair of rollers 23F rotate as the pull-out body 2 moves. Specifically, one roller of the pair of rollers 23E includes a right side roller 23E1, and the other roller of the pair of rollers 23E includes a left side roller 23E2. The right side roller 23E1 and the left side roller 23E2 rotate about a rotation axis extending substantially along the second direction D2. In addition, the right side roller 23E1 is attached to an end portion on the rear side (the side substantially in the direction opposite to the first direction DO of the right side plate portion 23C. The left side roller 23E2 is attached to an end portion on the rear side of the left side plate portion 23D. The right side roller 23E1 and the left side roller 23E2 are in contact with the bottom wall 1D.

Also, one roller of the pair of rollers 23F includes a right side roller 23F1, and the other roller of the pair of rollers 23F includes a left side roller 23F2. The right side roller 23F1 and the left side roller 23F2 rotate about a rotation axis extending substantially along the third direction D3. The right side roller 23F1 is attached to an end portion on the rear side of the right side plate portion 23C. The left side roller 23F2 is attached to an end portion on the rear side of the left side plate portion 23D. The right side roller 23F1 is in contact with the right wall 1A. The left side roller 23F2 is in contact with the left wall 1B.

The placing portion 22 and the support portion 23 are accommodated in the heating cooking chamber 100A when the lid portion 21 is positioned at the closed position. On the other hand, when the lid portion 21 is positioned at the open position, the placing portion 22 and the support portion 23 are pulled out from the heating cooking chamber 100A, in a state in which the pair of rollers 23E and the pair of rollers 23F are accommodated in the heating cooking chamber 100A.

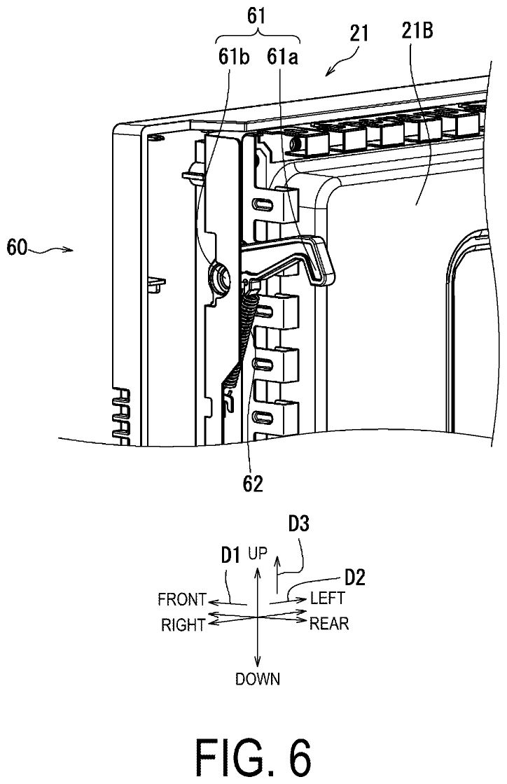

Next, the pull-out body 2 will be further described in detail. FIG. 6 is a perspective view illustrating an appearance of a part of the pull-out body 2 according to the first embodiment. As illustrated in FIG. 5 and FIG. 6, the pull-out type heating cooking apparatus 100 further includes two connecting members 60.

The two connecting members 60 connect the heating chamber 1 and the lid portion 21 when the lid portion 21 is positioned at the closed position. The two connecting members 60 include a first connecting member and a second connecting member, for example.

The first connecting member and the second connecting member are attached to the lid portion 21. The first connecting member and the second connecting member oppose each other in the left-right direction. The first connecting member is attached to an edge portion on the right side of the rear face 21B of the lid portion 21 and on the upper side of the placing portion 22. In addition, the second connecting member is attached to an edge portion on the left side of the rear face 21B of the lid portion 21 and on the upper side of the placing portion 22.

Specifically, each of the two connecting members 60 includes a hook member 61 and an elastic member 62.

The hook member 61 is a plate-like member having the front-rear direction as the longitudinal direction. The hook member 61 includes a claw portion 61a and a rotation pin portion 61b. The rotation pin portion 61b is positioned at one end portion of the hook member 61. The rotation pin portion 61b pivots about a rotation axis extending along the second direction D2. On the other hand, the claw portion 61a has a protruding portion that protrudes downward. The claw portion 61a is positioned at the other end portion of the hook member 61. As a result, the claw portion 61a is pivotable about the rotation pin portion 61b.

The elastic member 62 acts on the hook member 61 such that the claw portion 61a is positioned at a predetermined position with respect to the rear face 21B. The elastic member 62 is, for example, a coil spring. One end portion of the coil spring is attached to the hook member 61 and the other end portion of the coil spring is attached to the rear face 21B.

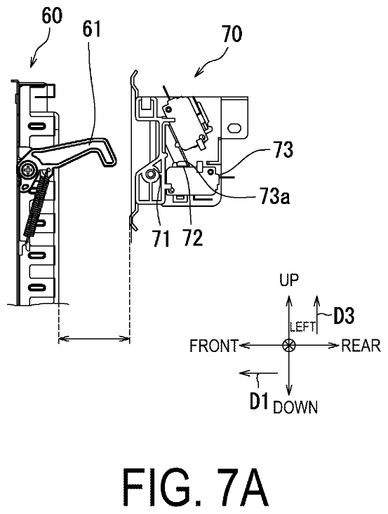

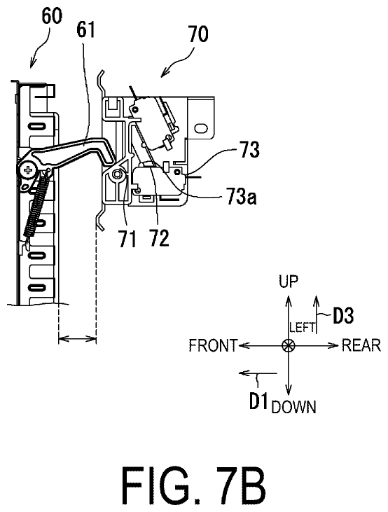

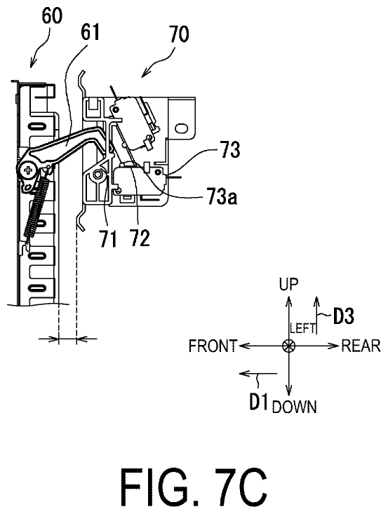

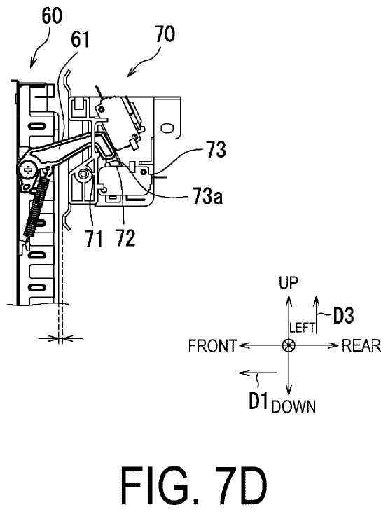

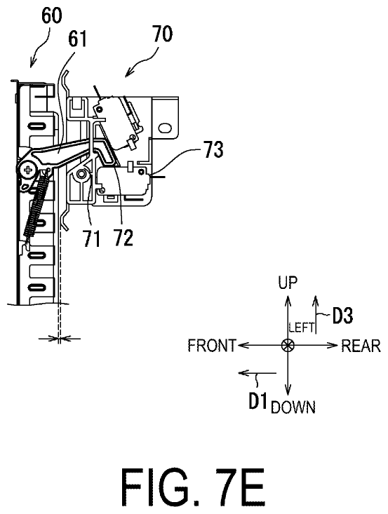

Next, a member to be connected 70 to which the connecting member 60 is connected will be described in detail with reference to FIG. 5 and FIG. 7A to FIG. 7E. FIG. 7A to FIG. 7E are cross-sectional views illustrating the connecting member 60 and the member to be connected 70 according to the first embodiment. As illustrated in FIG. 5 and FIG. 7A to FIG. 7E, the heating chamber 1 further includes a plurality of the members to be connected 70.

The number of the members to be connected 70 is the same as the number of the connecting members 60. The plurality of members to be connected 70 includes, for example, a first member to be connected and a second member to be connected.

The first member to be connected and the second member to be connected are attached to the heating chamber 1. The first member to be connected is attached to the edge portion on the right side of the panel 50 of the heating chamber 1 and on the upper side of the placing portion 22. In more detail, the first member to be connected is attached to the fifth through hole 55. Further, the second member to be connected is attached to the edge portion on the left side of the panel 50 of the heating chamber 1 and on the upper side of the placing portion 22. In more detail, the second member to be connected is attached to the fourth through hole 54.

Specifically, each of the two members to be connected 70 includes an inclined face portion 71 and a hole 72. The inclined face portion 71 has an inclined surface that gradually increases from a predetermined height. The hole 72 is positioned at a predetermined height, and is positioned on the rear side of the inclined face portion 71. A shape of the hole 72 corresponds to a shape of the claw portion 61a. One of the two members to be connected 70 further includes a sensor 73. The sensor 73 is an example of a “detection unit”.

The sensor 73 detects whether the lid portion 21 is present at the closed position. In more detail, the sensor 73 detects whether the connecting member 60 is present at the closed position. Specifically, the sensor 73 includes a switch 73a. The switch 73a is movable, for example, in the up-down direction. When the claw portion 61a is positioned in the hole 72, the claw portion 61a presses the switch 73a. For example, the claw portion 61a presses the switch 73a downward. As a result, the sensor 73 outputs a closing signal to the control unit 5. On the other hand, when the claw portion 61a is not positioned in the hole 72, the claw portion 61a does not press the switch 73a. As a result, the sensor 73 does not output the closing signal to the control unit 5. In other words, the sensor 73 outputs an opening signal to the control unit 5.

Here, a connection method for connecting the heating chamber 1 and the lid portion 21 will be described in detail. First, as illustrated in FIG. 7A, the drive motor 41 is driven to move the lid portion 21 from the open position to the closed position. In other words, a distance between the panel 50 and the rear face 21B decreases.

Next, when the distance between the panel 50 and the rear face 21B decreases, as illustrated in FIG. 7B, the claw portion 61a comes into contact with the inclined face portion 71 of the member to be connected 70.

Next, when the distance between the panel 50 and the rear face 21B decreases further, the claw portion 61a comes into contact with the inclined face portion 71 of the member to be connected 70, and thus, as illustrated in FIG. 7C, the claw portion 61a is pushed up from the predetermined position against the action of the elastic member 62.

Next, when the distance between the panel 50 and the rear face 21B decreases further, as illustrated in FIG. 7D, the claw portion 61a is pulled down to the predetermined position by the action of the elastic member 62.

As a result, as illustrated in FIG. 7E, the claw portion 61a is positioned in the hole 72. The distance between the panel 50 and the rear face 21B is a predetermined distance. In addition, the sensor 73 outputs the closing signal to the control unit 5 when the claw portion 61a is positioned in the hole 72.

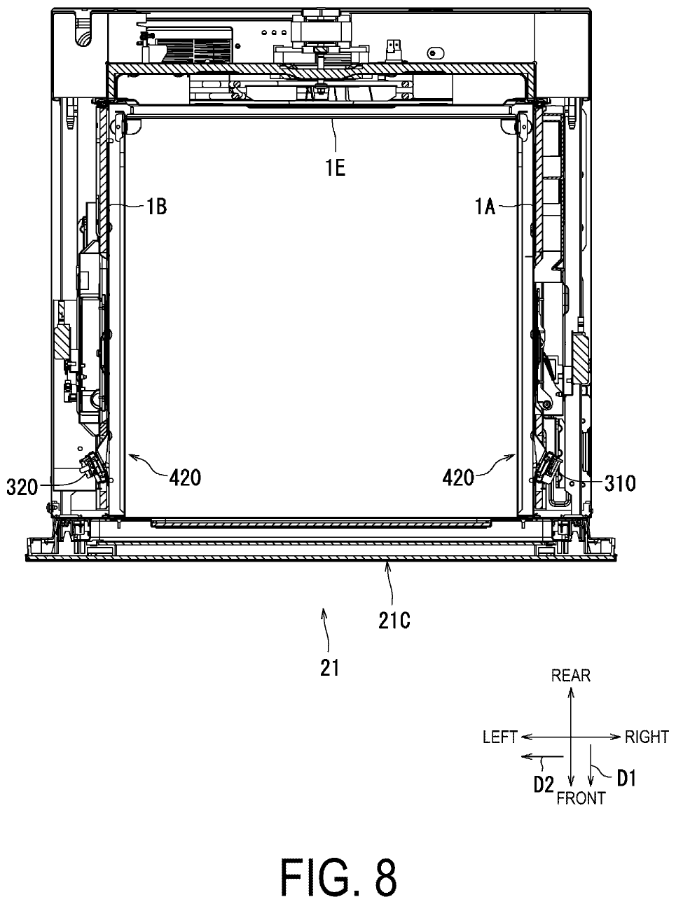

Next, the pull-out type heating cooking apparatus 100 will be described in detail with reference to FIG. 8. FIG. 8 is a cross-sectional view illustrating the pull-out type heating cooking apparatus 100. As illustrated in FIG. 8, the pull-out type heating cooking apparatus 100 further includes a first recessed portion 410, a first light source unit 310, a second recessed portion 420, and a second light source unit 320.

The first recessed portion 410 is disposed at the right wall 1A. The first recessed portion 410 is recessed from the right wall 1A. Specifically, the first recessed portion 410 is recessed from the right wall 1A in the direction opposite to the second direction D2.

In more detail, the first recessed portion 410 is disposed on the upper side of the right wall 1A. Specifically, the first recessed portion 410 is disposed above the upper end of the right side plate portion 23C. In addition, the first recessed portion 410 is disposed on the front side of the right wall 1A.

The first light source unit 310 includes, for example, a light emitting diode (LED). The first light source unit 310 is disposed at the first recessed portion 410. The first light source unit 310 emits light into the heating cooking chamber 100A.

The second recessed portion 420 is disposed at the left wall 1B. The second recessed portion 420 is recessed from the left wall 1B. Specifically, the second recessed portion 420 is recessed from the left wall 1B toward the second direction D2.

In more detail, the second recessed portion 420 is disposed on the upper side of the left wall 1B. Specifically, the second recessed portion 420 is disposed above the upper end of the left side plate portion 23D. In addition, the second recessed portion 420 is disposed on the front side of the left wall 1B.

The second light source unit 320 includes, for example, an LED. The second light source unit 320 is disposed at the second recessed portion 420. The second light source unit 320 emits light into the heating cooking chamber 100A.

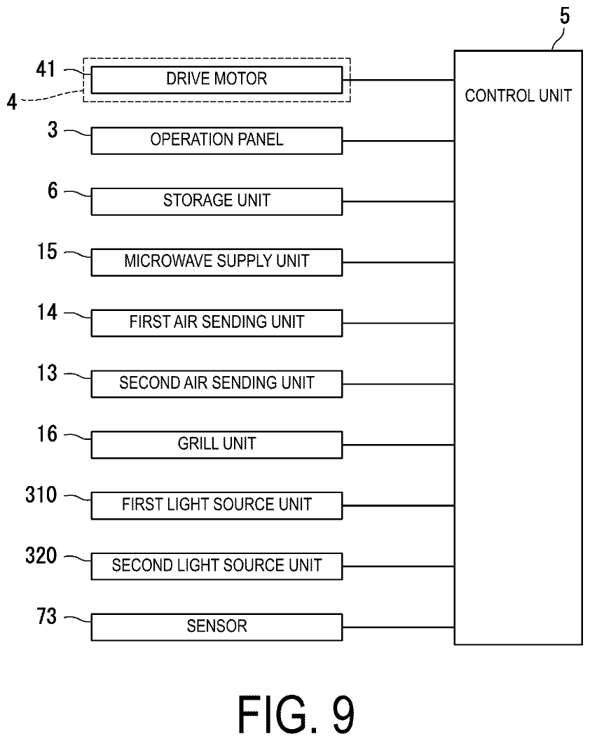

Next, a configuration of the pull-out type heating cooking apparatus 100 will be described in detail with reference to FIG. 9. FIG. 9 is a block diagram illustrating a configuration of the pull-out type heating cooking apparatus 100 according to the first embodiment. As illustrated in FIG. 9, the control unit 5 controls the sensor 73, the first air sending unit 14, the second air sending unit 13, the grill unit 16, the microwave supply unit 15, the first light source unit 310, the second light source unit 320, the drive motor 41, the operation panel 3, and the storage unit 6 by executing control programs stored in the storage unit 6.

The control unit 5 controls the first light source unit 310 and the second light source unit 320 based on a detection result of the sensor 73. Specifically, when the sensor 73 detects that the lid portion 21 is not present at the closed position, the control unit 5 controls the first light source unit 310 and the second light source unit 320 so that the first light source unit 310 and the second light source unit 320 emit light. In other words, when the lid portion 21 is opened, the first light source unit 310 and the second light source unit 320 emit the light. As a result, the interior of the heating cooking chamber 100A is illuminated.

On the other hand, when the sensor 73 detects that a state of the lid portion 21 being present at the closed position is maintained for a predetermined period of time or longer, the control unit 5 controls the first light source unit 310 and the second light source unit 320 so that the first light source unit 310 and the second light source unit 320 stop emitting the light. The predetermined period of time is, for example, 0.5 milliseconds. As a result, the interior of the heating cooking chamber 100A is not illuminated. In other words, when the sensor 73 detects that either the state of the lid portion 21 being present at the closed position or the state of the lid portion 21 not being present at the closed position is maintained for the predetermined period of time or longer, the control unit 5 controls the first light source unit 310 and the second light source unit 320.

Incidentally, when the lid portion 21 is closed, the lid portion 21 may vibrate due to an impact or the like generated when the lid portion 21 is closed. When the lid portion 21 vibrates, the sensor 73 repeats detecting that the lid portion 21 is not present at the closed position and detecting that the lid portion 21 is present at the closed position (the claw portion 61a rebounds, for example). For example, the sensor 73 detects that the lid portion 21 is not present at the closed position at a first time, detects that the lid portion 21 is present at the closed position at a second time, detects that the lid portion 21 is not present at the closed position at a third time, and detects that the lid portion 21 is present at the closed position at a fourth time. Note that the interval from the second time to the fourth time is, for example, 0.25 seconds.

In the first embodiment, the control unit 5 does not control the first light source unit 310 and the second light source unit 320 so that the first light source unit 310 and the second light source unit 320 stop emitting the light simply when the sensor 73 detects that the lid portion 21 is present at the closed position. As a result, the first light source unit 310 and the second light source unit 320 do not stop emitting the light when the sensor 73 detects that the lid portion 21 is present at the closed position at the second time. When the sensor 73 detects that the lid portion 21 is present at the closed position at the fourth time and further detects that the state of the lid portion 21 being present at the closed position is maintained for the predetermined period of time or longer, the first light source unit 310 and the second light source unit 320 stop emitting the light.

The first embodiment of the present invention has been described above. According to the first embodiment, the control unit 5 controls the first light source unit 310 and the second light source unit 320 when the sensor 73 detects that either the state of the lid portion 21 being present at the closed position or the state of the lid portion 21 not being present at the closed position is maintained for the predetermined period of time or longer. As a result, even if the lid portion 21 vibrates, it is possible to inhibit the first light source unit 310 and the second light source unit 320 from flashing on and off in an unintended manner.

In addition, when the sensor 73 detects that the state of the lid portion 21 being present at the closed position is maintained for the predetermined period of time or longer, the control unit 5 controls the first light source unit 310 and the second light source unit 320 so that the first light source unit 310 and the second light source unit 320 stop emitting the light. As a result, when the lid portion 21 is closed, even if the lid portion 21 vibrates due to the impact or the like generated when the lid portion 21 is closed, it is possible to inhibit the first light source unit 310 and the second light source unit 320 from flashing on and off in the unintended manner.

In addition, since the pull-out type heating cooking apparatus 100 further includes the connecting members 60, the heating chamber 1 and the lid portion 21 can be firmly connected to each other. According to the first embodiment, when heating chamber 1 and lid portion 21 can be firmly connected to each other, the first light source unit 310 and second light source unit 320 can stop emitting the light.

In addition, in the pull-out type heating cooking apparatus 100, since the predetermined distance is provided between the panel 50 and the rear face 21B at the closed position, microwaves can be supplied into the heating cooking chamber 100A. According to the first embodiment, when the microwaves can be supplied into the heating cooking chamber 100A, the first light source unit 310 and the second light source unit 320 can stop emitting the light.

Since the glass plate portion 21C includes the first glass plate and the second glass plate, the weight of the lid portion 21 is increased. As a result, when the lid portion 21 is closed, the lid portion 21 is likely to vibrate due to the impact or the like generated when the lid portion 21 is closed. According to the first embodiment, even if the lid portion 21 vibrates, it is possible to inhibit the first light source unit 310 and the second light source unit 320 from flashing on and off in the unintended manner.

Furthermore, the pull-out type heating cooking apparatus 100 further includes the drive mechanism 4. As a result, when the lid portion 21 is closed, the lid portion 21 is likely to vibrate due to the impact or the like generated when the lid portion 21 is closed. According to the first embodiment, even if the lid portion 21 vibrates, it is possible to inhibit the first light source unit 310 and the second light source unit 320 from flashing on and off in the unintended manner.

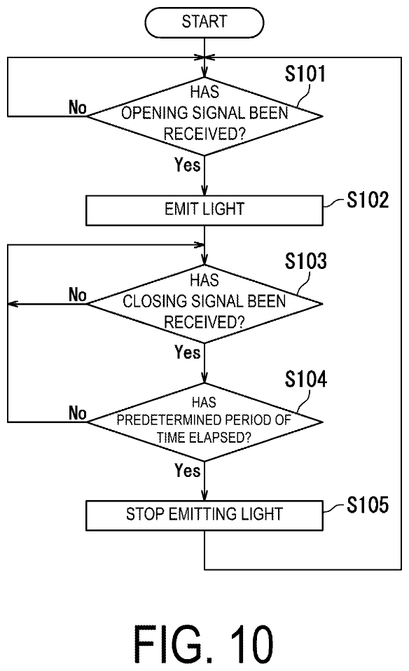

Next, a control method by the pull-out type heating cooking apparatus 100 according to the first embodiment will be described with reference to FIG. 10. FIG. 10 is a flowchart for explaining the control method by the pull-out type heating cooking apparatus 100. As illustrated in FIG. 10, at step S101, the control unit 5 determines whether the opening signal has been received.

When the control unit 5 determines at step S101 that the opening signal has not been received, the processing returns to step S101.

On the other hand, when the control unit 5 determines at step S101 that the opening signal has been received, the processing proceeds to step S102. At step S102, the control unit 5 controls the first light source unit 310 and the second light source unit 320 so that the first light source unit 310 and the second light source unit 320 emit the light. As a result, the interior of the heating cooking chamber 100A is illuminated.

Next, at step S103, the control unit 5 determines whether the closing signal has been received. When the control unit determines at step S103 that the closing signal has not been received, the processing returns to step S103.

On the other hand, when the control unit 5 determines at step S103 that the closing signal has been received, the processing proceeds to step S104. At step S104, the control unit 5 determines whether the predetermined period of time has elapsed. When the control unit 5 determines at step S104 that the predetermined period of time has not elapsed, the processing returns to step S103.

On the other hand, when the control unit 5 determines at step S104 that the predetermined period of time has elapsed, the processing returns to step S105. At step S105, the control unit 5 controls the first light source unit 310 and the second light source unit 320 so that the first light source unit 310 and the second light source unit 320 stop emitting the light. As a result, the interior of the heating cooking chamber 100A is not illuminated. Then, the processing returns to step S101.

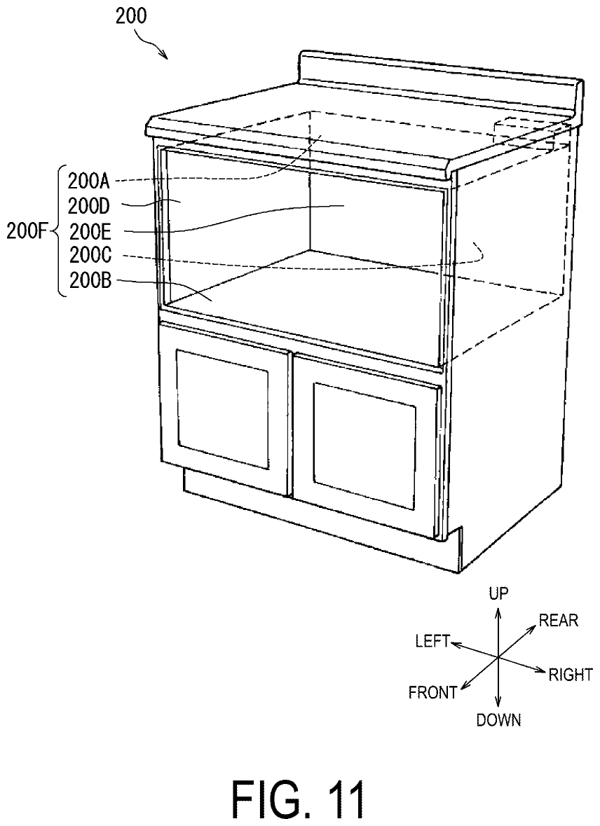

Next, a cabinet 200 to which the pull-out type heating cooking apparatus 100 is attached will be described with reference to FIG. 11. FIG. 11 is a diagram illustrating an appearance of the cabinet 200 to which the pull-out type heating cooking apparatus 100 according to the first embodiment is attached.

The pull-out type heating cooking apparatus 100 is installed in the cabinet 200 in a built-in manner. As illustrated in FIG. 11, the cabinet 200 includes an upper wall 200A, a lower wall 200B, a right wall 200C, a left wall 200D, and a rear wall 200E. The upper wall 200A, the lower wall 200B, the right wall 200C, the left wall 200D, and the rear wall 200E form an accommodation portion 200F. The accommodation portion 200F is a rectangular parallelepiped space into which the pull-out type heating cooking apparatus 100 is fitted.

### Second Embodiment

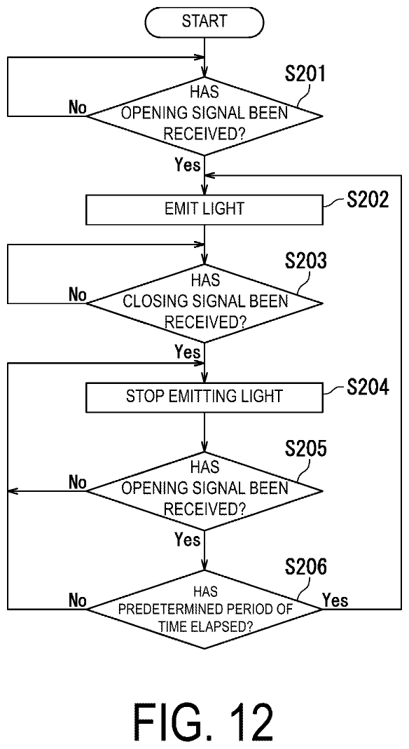

A second embodiment of the present invention will be described with reference to FIG. 9 and FIG. 12. However, matters that are different from those of the first embodiment will be described, and description of the same matters as those of the first embodiment will be omitted. The second embodiment is different from the first embodiment in that the first light source unit 310 and the second light source unit 320 emit the light when the sensor 73 detects that the state of the lid portion 21 not being present at the closed position is maintained for a predetermined period of time or longer.

As illustrated in FIG. 9, the control unit 5 controls the first light source unit 310 and the second light source unit 320 based on the detection result of the sensor 73. Specifically, when the sensor 73 detects that the state of the lid portion 21 not being present at the closed position is maintained for the predetermined period of time or longer, the control unit 5 controls the first light source unit 310 and the second light source unit 320 so that the first light source unit 310 and the second light source unit 320 emit the light. The predetermined period of time is, for example, 0.5 milliseconds.

On the other hand, when the sensor 73 detects that the lid portion 21 is present at the closed position, the control unit 5 controls the first light source unit 310 and the second light source unit 320 so that the first light source unit 310 and the second light source unit 320 stop emitting the light. In other words, when the lid portion 21 is closed, the first light source unit 310 and the second light source unit 320 stop emitting the light.

When the lid portion 21 vibrates, the sensor 73 repeats detecting that the lid portion 21 is not present at the closed position and detecting that the lid portion 21 is present at the closed position. For example, the sensor 73 detects that the lid portion 21 is not present at the closed position at a first time, detects that the lid portion 21 is present at the closed position at a second time, detects that the lid portion 21 is not present at the closed position at a third time, and detects that the lid portion 21 is present at the closed position at a fourth time.

In the second embodiment, the control unit 5 does not control the first light source unit 310 and the second light source unit 320 so that the first light source unit 310 and the second light source unit 320 emit the light, simply when the sensor 73 detects that the lid portion 21 is not present at the closed position. As a result, the first light source unit 310 and the second light source unit 320 emit the light when the sensor 73 detects that the lid portion 21 is not present at the closed position at the first time and further detects that the state of the lid portion 21 not being present at the closed position is maintained for the predetermined period of time or longer. When the sensor 73 detects that the lid portion 21 is present at the closed position at the second time, the first light source unit 310 and the second light source unit 320 stop emitting the light. The first light source unit 310 and the second light source unit 320 do not emit the light simply when the sensor 73 detects that the lid portion 21 is not present at the closed position at the third time. The first light source unit 310 and the second light source unit 320 emit the light when the sensor 73 detects that the lid portion 21 is not present at the closed position and further detects that the state of the lid portion 21 not being present at the closed position is maintained for the predetermined period of time or longer. Note that the interval from the second time to the fourth time is, for example, 0.25 seconds.

The second embodiment of the present invention has been described above. According to the second embodiment, the control unit 5 controls the first light source unit 310 and the second light source unit 320 so that the first light source unit 310 and the second light source unit 320 stop emitting the light when the sensor 73 detects that the state of the lid portion 21 not being present at the closed position is maintained for the predetermined period of time or longer. As a result, when the lid portion 21 is closed, even if the lid portion 21 vibrates due to the impact or the like generated when the lid portion 21 is closed, it is possible to inhibit the first light source unit 310 and the second light source unit 320 from flashing on and off in the unintended manner.

Next, a control method by the pull-out type heating cooking apparatus 100 according to the second embodiment will be described with reference to FIG. 12. FIG. 12 is a flowchart for explaining the control method by the pull-out type heating cooking apparatus 100. As illustrated in FIG. 12, at step S201, the control unit 5 determines whether the opening signal has been received.

When the control unit 5 determines at step S201 that the opening signal has not been received, the processing returns to step S201.

On the other hand, when the control unit 5 determines at step S201 that the opening signal has been received, the processing proceeds to step S202. At step S202, the control unit 5 controls the first light source unit 310 and the second light source unit 320 so that the first light source unit 310 and the second light source unit 320 emit the light. As a result, the interior of the heating cooking chamber 100A is illuminated.

Next, at step S203, the control unit 5 determines whether the closing signal has been received. When the control unit 5 determines at step S203 that the closing signal has not been received, the processing returns to step S203.

On the other hand, when the control unit 5 determines at step S203 that the closing signal has been received, the processing proceeds to step S204. At step S204, the control unit 5 controls the first light source unit 310 and the second light source unit 320 so that the first light source unit 310 and the second light source unit 320 stop emitting the light. As a result, the interior of the heating cooking chamber 100A is not illuminated.

Next, at step S205, the control unit 5 determines whether the opening signal has been received. When the control unit 5 determines at step S205 that the opening signal has not been received, the processing returns to step S204.

On the other hand, when the control unit 5 determines at step S205 that the opening signal has been received, the processing proceeds to step S206. At step S206, the control unit 5 determines whether the predetermined period of time has elapsed. When the control unit 5 determines at step S206 that the predetermined period of time has not elapsed, the processing returns to step S204.

On the other hand, when the control unit 5 determines at step S206 that the predetermined period of time has elapsed, the processing returns to step S202.

The embodiments of the present invention have been described above with reference to the accompanying drawings. However, the present invention is not limited to the embodiments described above, and the present invention can be implemented in various modes without departing from the gist thereof. The drawings primarily schematically illustrate each of the constituent elements for the sake of easier understanding, and the thickness, length, quantity, and the like of each of the illustrated constituent elements are different from the actual thickness, length, quantity, and the like by reason of creation of the drawings. Further, the material, shape, dimensions, and the like of each of the constituent elements illustrated in the embodiments described above are merely examples and are not particularly limited, and various modifications can be made within the scope not substantially departing from the effects of the present invention.
(1) As described with reference to FIG. 1 to FIG. 12, the pull-out type heating cooking apparatus 100 includes the drive mechanism 4, but the present invention is not limited thereto. The pull-out type heating cooking apparatus 100 may not include the drive mechanism 4. Specifically, the user may move the lid portion 21 along the first direction D1 with respect to the heating cooking chamber 100A.
(2) As described with reference to FIG. 1 to FIG. 12, the pull-out type heating cooking apparatus 100 includes the first light source unit 310 and the second light source unit 320, but the present invention is not limited thereto. The pull-out type heating cooking apparatus 100 may include only the first light source unit 310, may include only the second light source unit 320, or may further include a third light source unit.

### INDUSTRIAL APPLICABILITY

The present invention provides a heating cooking apparatus, and the provided heating cooking apparatus has industrial applicability.

### REFERENCE SIGNS LIST

1 Pull-out type heating cooking apparatus (heating cooking apparatus)
100A Heating cooking chamber
100B Opening
310 First light source unit
320 Second light source unit

1. A heating cooking apparatus comprising:
a heating cooking unit including an opening and a heating cooking chamber communicated with the opening;
a lid portion configured to move between a closed position at which the lid portion covers the opening and an open position at which the lid portion opens the opening;
a detection unit configured to detect whether the lid portion is present at the closed position;
a light source unit configured to emit light into the heating cooking chamber; and
a control unit configured to control the light source unit,
wherein the control unit controls the light source unit when the detection unit detects that either a state of the lid portion being present at the closed position or a state of the lid portion not being present at the closed position is maintained for a predetermined period of time or longer.

2. The heating cooking apparatus according to claim 1,
wherein the control unit controls the light source unit to cause the light source unit to stop emitting the light when the detection unit detects that the state of the lid portion being present at the closed position is maintained for the predetermined period of time or longer.

3. The heating cooking apparatus according to claim 1,
wherein the control unit controls the light source unit to cause the light source unit to emit the light when the detection unit detects that the state of the lid portion not being present at the closed position is maintained for the predetermined period of time or longer.

4. The heating cooking apparatus according to claim 1, further comprising
a connecting member configured to connect the heating cooking unit and the lid portion when the lid portion is positioned at the closed position,
wherein the detection unit detects whether the connecting member is present at the closed position.

5. The heating cooking apparatus according to claim 1, further comprising
a microwave supply unit configured to supply microwaves into the heating cooking chamber,
wherein the heating cooking unit includes a first face disposed at an outer periphery of the opening,
the lid portion includes a second face facing the first face, and
a predetermined distance is provided between the first face and the second face when the lid portion is positioned at the closed position.

6. The heating cooking apparatus according to claim 1,
wherein the lid portion includes
a first glass plate, and
a second glass plate facing the first glass plate.

7. The heating cooking apparatus according to claim 1, further comprising
a drive mechanism configured to move the lid portion along a predetermined direction with respect to the heating cooking chamber.
